(19) United States
(12) Patent Application Publication
(10) Pub. No.: US 2026/0065943 A1
(43) Pub. Date: Mar. 5, 2026

(54) CLOSED CAPTION TEXT, VIDEO PROCESSING, AND SYNCHRONIZATION ANALYSIS

(71) Applicant: Charter Communications Operating, LLC, St. Louis, MO (US)

(72) Inventor: Matthew S. Reynolds, Aurora (CO)

(21) Appl. No.: 18/819,131

(22) Filed: Aug. 29, 2024

(51) Int. Cl. G11B 27/36; G11B 27/34

(52) U.S. Cl. CPC G11B 27/36; G11B 27/34

(57) ABSTRACT

A management resource can be configured to receive a first text string associated with first content; the first text string is derived from a first audio sample of the first content. The management resource further receives a second text string associated with the first content; the second text string is derived from a first image sample of the first content. The management resource determines a first quality of playback timing alignment between the first audio sample and the first image sample based on comparison of the first text string and the second text string.

### BACKGROUND

Closed Captioning (a.k.a., CC) includes techniques of determining uttered words (associated with an audio signal) in a respective video asset and converting the uttered words into text form for display on a display screen. During playback of the respective video asset, the text form of those uttered words is typically displayed on the display screen at or around the time that the words are uttered with respect to corresponding images on the display screen. Accordingly, the display of closed captioning text and corresponding video provides a way of apprising a deaf person of the uttered words even though they are not audibly detectable by the deaf person.

### BRIEF DESCRIPTION OF EXAMPLES

As discussed herein, a management resource receives a first text string associated with first content. The first text string is derived from a first audio sample of the first content. The management resource also receives a second text string associated with the first content. The second text string may be derived from a first image sample of the first content. In one example, the management resource determines a first quality of playback timing alignment between the first audio sample and the first image sample based on comparison of the first text string and the second text string.

In accordance with further examples, the first audio sample is obtained from an audio signal associated with the first content. The first image sample is obtained from an image signal associated with the first content. The image signal includes text information encoded for playback on a display screen at/or around the time the first audio sample is playback. The management resource can be configured to use a time stamp value associated with the first audio sample to obtain the first image sample of the first content.

Yet further, a first quality of playback timing alignment between the first audio sample and the first image sample may include determining a degree to which the first text string and the second text string are similar to each other. Determining the degree to which the first text string and the second text string are similar to each other may include the management resource: producing a metric based on a percentage of first words present in the first text string that match second words present in the second text string.

Additionally, the management resource as discussed herein can be configured to: receive a third text string; the third text string being associated with second content. The third text string can be derived from a second audio sample obtained from the second content. The management resource also can be configured to: receive a fourth text string associated with the second content. The fourth text string can be derived from a second image sample from the second content. Management resource determines a second quality of playback timing alignment between the second audio sample and the second image sample based on comparison of the third text string and the fourth text string. The management resource can be configured to: produce a first metric indicating a degree to which the first text string and the second text string are similar to each other; and produce a second metric indicating a degree to which the third text string and the fourth text string are similar to each other. As discussed herein, the second text string and the fourth text string may be obtained from closed-captioned information. Based on comparing the first metric and the second metric, the management resource determines which of the first content or the second content the closed-captioned information is better synchronized. Accordingly, initially, it may not be known what specific video asset the closed-captioned information pertains. The management resource can be configured to determine from the metric comparison which of the first content or the second content the closed-captioned information was originally generated.

Still further examples as discussed herein include the management resource converting the first audio sample of the first content into the first text string. The first text string can be configured to include text representing words spoken in the first audio sample.

In another example, the management resource is configured to: receive a third text string associated with the first content, the third text string derived from a second audio sample of the first content; receive a fourth text string associated with the first content, the fourth text string derived from a second image sample of the first content; and determine a second quality of playback timing alignment between the second audio sample and the second image sample based on comparison of the third text string and the fourth text string. In one example, the first audio sample and the second audio sample are obtained from an audio signal associated with the first content; the first image sample and the second image sample are obtained from an image signal associated with the first content. The management resource can be configured to, based on the determined first quality of playback timing alignment and the determined second quality of playback timing alignment, produce a metric indicating a degree of synchronization between the audio signal and the image signal.

In accordance with still further examples, note that the first audio sample as discussed herein may be obtained from an audio signal associated with the first content; the first image sample may be obtained from an image signal associated with the first content. In response to detecting that the first quality of playback timing alignment falls below a threshold level, the management resource can be configured to adjust synchronization of playing back the audio signal and corresponding closed-captioned text encoded in the image signal. In other words, techniques herein may include synchronization (timing) adjustments such that an audible playback of words associated with video is synchronized with playback of corresponding closed captioned images of the video.

As a further example, the management resource can be configured to: receive an audio sample from a video asset; determine a timestamp of the received audio sample, the timestamp indicating a corresponding location in the video asset playing back the audio sample; convert the received audio sample into a corresponding audio-to-text sample; via the timestamp, obtain an image from the video asset; process the obtained image to produce a text string indicative of text displayed in the image of the video asset; and based on comparing the audio-to-text sample to the text string produced from the image, determine a quality of playback alignment between the audio sample and the text string.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), or non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes a computer readable storage medium and/or system having instructions stored thereon to facilitate better use of available wireless resources. The instructions, when executed by computer processor hardware, cause the computer processor hardware (such as one or more co-located or disparately processor devices or hardware) to: receive a first text string associated with first content, the first text string derived from a first audio sample of the first content; receive a second text string associated with the first content, the second text string derived from a first image sample of the first content; and determine a first quality of playback timing alignment between the first audio sample and the first image sample based on comparison of the first text string and the second text string.

Another example as discussed herein includes a computer readable storage medium and/or system having instructions stored thereon to facilitate better use of available wireless resources. The instructions, when executed by computer processor hardware, cause the computer processor hardware (such as one or more co-located or disparately processor devices or hardware) to: receive an audio sample from a video asset; determine a timestamp of the received audio sample, the timestamp indicating a corresponding location in the video asset playing back the audio sample; convert the received audio sample into a corresponding audio-to-text sample; via the timestamp, obtain image data from the video asset; process the obtained image data to produce a text string indicative of text displayed in the image of the video asset; and based on comparing the audio-to-text sample to the text string produced from the image data, determine a quality of playback alignment between the audio sample and the text string.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of content distribution. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a test environment for analyzing synchronization quality of closed-captioned information with respect to different versions of video content as discussed herein.

FIGS. 2A and 2B combine to form an example flow chart illustrating analysis of synchronization quality of closed-captioned information with respect to different versions of video content as discussed herein.

FIG. 3 is an example diagram illustrating combining of closed-captioned information with the first version of content and corresponding analysis of same as discussed herein.

FIG. 4 is an example diagram illustrating analysis of synchronization between audio information and closed-captioned information at a first timestamp as discussed herein.

FIG. 5 is an example diagram illustrating analysis of synchronization between audio information and closed-captioned information at a second timestamp as discussed herein.

FIG. 6 is an example diagram illustrating combining of closed-captioned information with the first version of content and corresponding analysis of same as discussed herein.

FIG. 7 is an example diagram illustrating analysis of synchronization between audio information and closed-captioned information at a first timestamp as discussed herein.

FIG. 8 is an example diagram illustrating analysis of synchronization between audio information and closed-captioned information at a second timestamp as discussed herein.

FIG. 9 is an example diagram illustrating example computer architecture operable to execute one or more operations as discussed herein.

FIG. 10 is an example diagram illustrating a method as discussed herein.

FIG. 11 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

One example as discussed herein includes determining whether playback of closed-captioned text information associated with video is properly synchronized with playback of an audio signal.

For example, a management resource as discussed herein receives an audio sample from a video asset. The management resource determines a timestamp of the received audio sample. The timestamp indicates a corresponding location in the video asset playing back the audio sample. The management resource converts the received audio sample into a corresponding audio-to-text sample. Via the timestamp, the management resource obtains image data from the video asset. The management resource processes the obtained image data to produce a text string indicative of text encoded in the image data of the video asset. Based on comparing the audio-to-text sample to the text string produced from the image data, the management resource determines a quality of playback alignment between the audio sample and the text string.

Accordingly, the management resource can be configured to receive a first text string associated with first content, where the first text string is derived from a first audio sample of the first content. The management resource further receives a second text string associated with the first content, where the second text string is derived from a first image sample of the first content. The management resource determines a first quality of playback timing alignment between the first audio sample and the first image sample based on comparison of the first text string and the second text string.

In one example, if the determined alignment between the first audio sample and the first image sample is better (less) than a threshold level, it may be assumed that the closed-captioned text information is associated with video pertains to the corresponding video asset. If the determined alignment between the first audio sample and the first image sample is greater than a threshold level, it may be assumed that the closed-captioned text information is not associated with video pertains to the corresponding video asset.

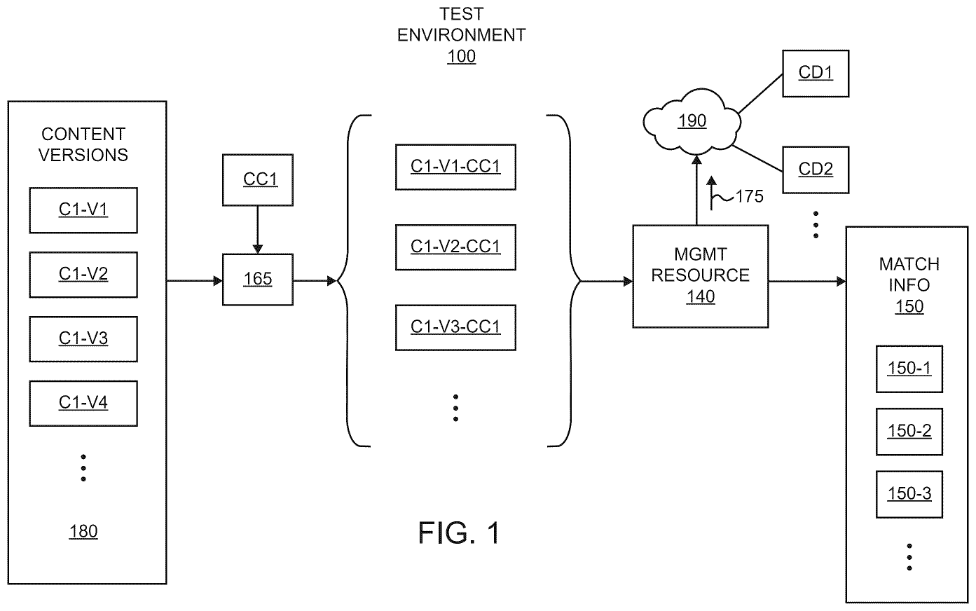

Now, more specifically, with reference to the drawings, FIG. 1 is an example diagram illustrating a test environment for analyzing synchronization quality of closed-captioned information with respect to different versions of video content as discussed herein.

As shown, test environment 100 includes repository 180 (such as one or more storage resources) to store different versions of content and corresponding closed-captioned information and management resource 140.

In this example, the repository 180 stores multiple versions of content associated with the same video title. For example, the repository 180 stores multiple versions of content C1 (such as a title of content such as the movie “JAWS”) including a first version content C1-V1 (first version of the movie “JAWS”), second version of content C1-V2 (second version of the movie “JAWS”), third version of content C1-V3 (third version of the movie “JAWS”), fourth version of content C1-V4 (fourth version of the movie “JAWS”), and so on.

Note that each of the different versions of the content C1 may be slightly or grossly different than each other. For example, each of the different versions of the content C1 may be of a different length, include different scenes, etc.

Assume in this example that a closed-captioned generator generates the closed-captioned information CC1 associated with a specific version of the content C1 but it is not known which version of the content C1 the closed-captioned information CC1 pertains. In such an instance, the test environment 100 implements management resource 140 to test and determine which of the multiple different versions of the content C1 the closed-captioned information CC1 pertains.

Because the closed-captioned information CC1 has been generated based on a single version of the content C1 such as in this example, use of the closed-captioned information CC1 with any of the other versions of the content C1 most likely will be grossly out of synchronization. In other words, use of the particular version of the content C1 for which the closed-captioned information CC1 has been generated will result in good synchronization between displayed closed-captioned text and play black of corresponding audio. Use of any version other than the particular version of the content C1 for which the closed-captioned information CC1 has been generated will result in poor synchronization between displayed closed-captioned text and play black of corresponding audio.

As further shown, for testing purposes, the management resource 140 or other suitable entity such as combiner function 165 produces the video content C1-V1-CC1 based on combining the content C1-V1 and the closed-captioned information CC1; the management resource 140 or other suitable entity such as combiner function 165 produces the video content C1-V2-CC1 based on combining the content C1-V2 and the closed-captioned information CC1; the management resource 140 or other suitable entity such as combiner function 165 produces the video content C1-V3-CC1 based on combining the content C1-V3 and the closed-captioned information CC1; and so on.

Playback of the content C1-V1-CC1 results in an overlay of closed-captioned text information CC1 on the display screen with respect to the original video content associated with content C1-V1; playback of the content C1-V2-CC1 results in an overlay of closed-captioned text information CC1 on the display screen with respect to the original video content associated with content C1-V2; playback of the content C1-V3-CC1 results in an overlay of closed-captioned text information CC1 on the display screen with respect to the original video content associated with content C1-V3; and so on.

As previously discussed, the closed-captioned information CC1 may be generated specifically for only one of the different versions of content C1. The management resource 140 performs analysis to determine which of the versions of content C1-V1, C1-V2, C1-V3, etc., the closed caption information CC1 pertains.

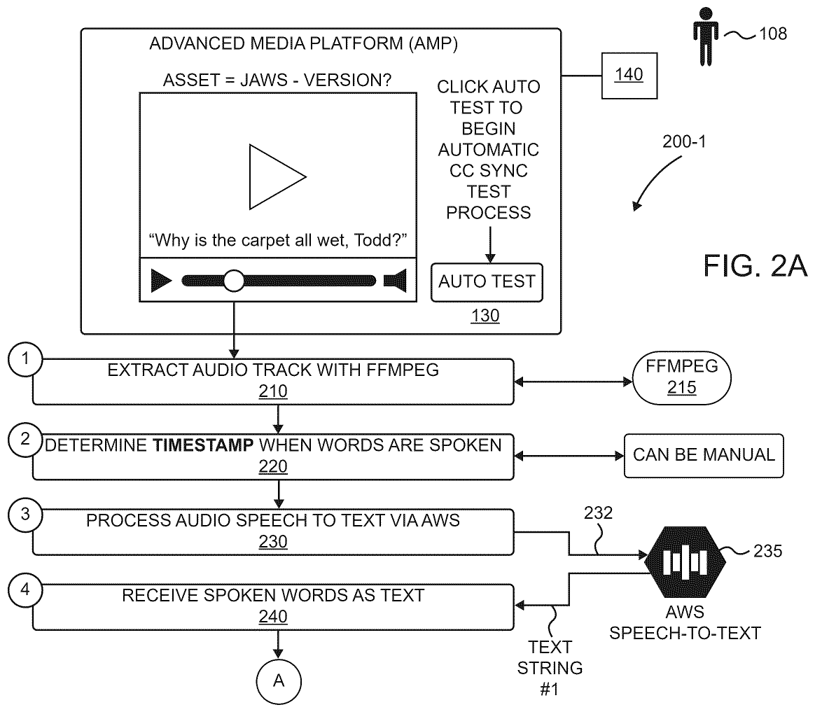

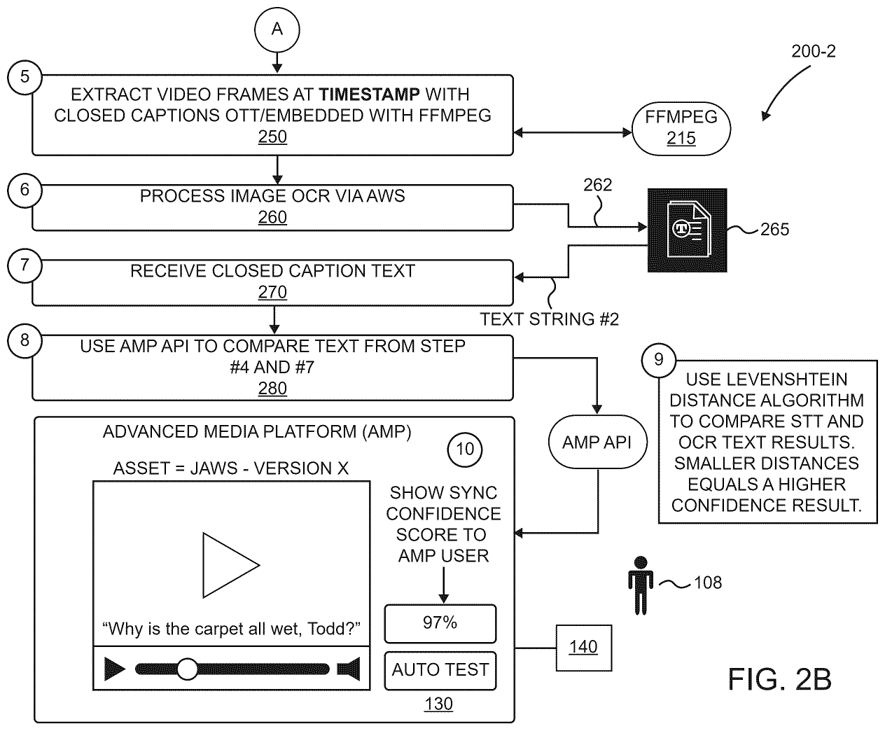

FIGS. 2A and 2B combine to form an example flow chart 200 illustrating analysis of synchronization quality of closed-captioned information with respect to different versions of video content as discussed herein.

In this example, the test environment 100 includes management resource 140 and corresponding display screen 130 operated by the user 108. For a given version of content under test (such as for each of different versions of content C1, JAWS movie), the user 108 operates the management resource 140 and corresponding display screen to determine which of the multiple versions of content C1 the closed-captioned information CC1 pertains.

Note that the operations as discussed herein may be completely automated in which the user 108 may not be present for testing. In such an instance, the management resource 140 performs any needed operations to implement testing.

Further in this example, initially, assume that the user 108 chooses a respective asset such as content C1 for testing. As previously discussed, it may not be known which of the different versions of the content C1-V1, C1-V2, C1-V3, C1-V4, etc., associated with the content C1 the corresponding closed-captioned information CC1 pertains. To determine which of the different versions of the content the closed-captioned information CC1 was originally generated, the management resource 140 tests each of the different instances of content C1. In one example, the management resource 140 or other suitable entity such as combiner function 165 combines an instance of closed-captioned information CC1 with each of the different versions of content C1 for testing and determining which of the versions the closed-captioned information CC 1 pertains. That is, the management resource 140 or combiner function 165 combines the closed-captioned information CC1 with each of the versions of content C1-V1, C1-V2, C1-V3, etc., to produce the respective closed-captioned video content C1-V1-CC1, closed-captioned video content C1-V1-CC1, closed-captioned video content C1-V1-CC1, etc.

More specifically, in one example, the closed-captioned information CC1 indicates text information to display on a display screen and corresponding timestamps with respect to the content C1. For example, the closed-captioned information CC1 may indicate to: display a first text sequence in played back video content C1 at a first timestamp TS1 of the content C1, display a second text sequence in played back video content C1 at a second timestamp of the content C1, display a third text sequence in played back video content C1 at a third timestamp TS3 of the content C1, display a fourth text sequence in played back video content C1 at a fourth timestamp TS4 of the content C1, and so on.

As previously discussed, each of the different versions of the content C1 may include different scenes, resulting in the text information (closed-captioned text) and timestamp information (indicating when to display the text information) in the closed-captioned information CC1 being a mismatch when played back for all versions of the content C1 except the specific one version of the content C1 for which the closed-captioned information CC1 was originally generated.

Assume in this example that the closed-captioned information CC1 was generated for the content C1-V2 and that the management resource 140 is not aware of this association and must check each of the different versions to determine which specific version of the content C1 the closed-captioned information CC1 was created. In such an instance, the manager resource 140 tests each of the different instances of video content C1-V1-CC1, video content C1-V2-CC1, video content C1-V3-CC1, etc., to determine the specific version for which the closed-captioned information C1 was created.

As further shown in flowchart 200-1, at processing operation 210, the management resource 140 extracts a sample from the audio track associated with the content under test such as C1-V1-CC1. In one example, the extraction is implemented via an extraction function 215 such as so-called FFMPEG (Fast Forward Moving Picture Experts Group). However, note that any extraction technique can be used to determine an audio sample at a particular location in the content under test C1-V1-C11.

Further, in processing operation 220, the management resource 140 determines a respective time stamp when words are spoken in the corresponding content under test C1-V1-CC1.

In processing operation 230, via the text to speech converter function 235, the management resource 140 processes the spoken words (audio speech such as audio sample 232) to produce a respective text string for the spoken words around a window of time as indicated by or associated with the respective timestamp.

In processing operation 240, the management resource 140 receives a respective text string #1 from the text-to-speech converter 235. The received text string #1 is a text version of the spoken words in the content under test C1-V1-11 present for playback at a time specified by the respective timestamp.

Processing further continues at processing operation 250 in FIG. 2B. In processing operation 250 of flowchart 200-2, the management resource 140 extracts video frames (images or image data) from the content under test C1-V1-CC1 at the specified timestamp using the extraction function 255. The extracted image data includes embedded text string information (an encoded image form) associated with the closed-captioned information CC1.

In processing operation 260, the management resource 140 processes the retrieved image information or data (such as via optical character recognition or other manner) to convert the retrieved image information (closed-captioned information) into a text string #2 of closed-captioned text. This includes the management resource 140 implementing the text extraction function 265 (such as Amazon Textract™ or other suitable function) via forwarding of the text image sample 262 to the text extraction function 265. The text extraction function 265 converts the received text image sample 262 into the text string #2 supplied to the management resource 140 in processing operation 270. Accordingly, the management resource 140 can be configured to receive the text string #2 from the text extraction function 265.

As further shown, in processing operation 280, the management resource 140 compares the text string #1 to the text string #2 for similarity to determine whether the spoken words in the audio as specified the text string #1 match the corresponding closed-captioned text information as indicated by text string #2.

If there is a good match between text string #1 and text string #2, then the closed-captioned information CC1 most likely was generated for the content under test C1-Vx-CC1 (where x=1, 2, 3, etc.). Alternatively, if there is a poor match between the text string #1 and text string #2, then the closed-captioned information CC 1 most likely was not generated for the content under test C1-Vx-CC1.

In this example, assume that the content under test C1-Vx-CC1 is C1-V2-CC1. In such an instance, because the closed-captioned information CC1 was generated for the content C1-V2, there is a good match (match information 150-2) between the text string #1 and the text string #2, resulting in a high confidence score such as 97 percent or other suitable value. Because the confidence level of 97 percent is greater than a threshold level such as 80 percent or other suitable value, the management resource 140 provides notification to the user 108 or other suitable entity that the closed-captioned information CC1 was generated for the version of content C1-V2.

Based on the determination that the closed-captioned information CC 1 was generated for the content C1-V2, the management resource 140 or other suitable entity can be configured to provide availability of the content C1-V2-CC1 for playback by any requesting communication devices in a network environment.

Accordingly, the management resource 140 as discussed herein can be configured to: receive an audio sample from a video asset (C1-V2-CC1); determine a timestamp of the received audio sample, the timestamp indicating a corresponding location in the video asset playing back the audio sample; convert the received audio sample into a corresponding audio-to-text sample; via the timestamp, obtain an image from the video asset; processing the obtained image to produce a text string indicative of text displayed in the image of the video asset; and based on comparing the audio-to-text sample to the text string produced from the image, determine a quality of playback alignment (match information 150) between the audio sample and the text string.

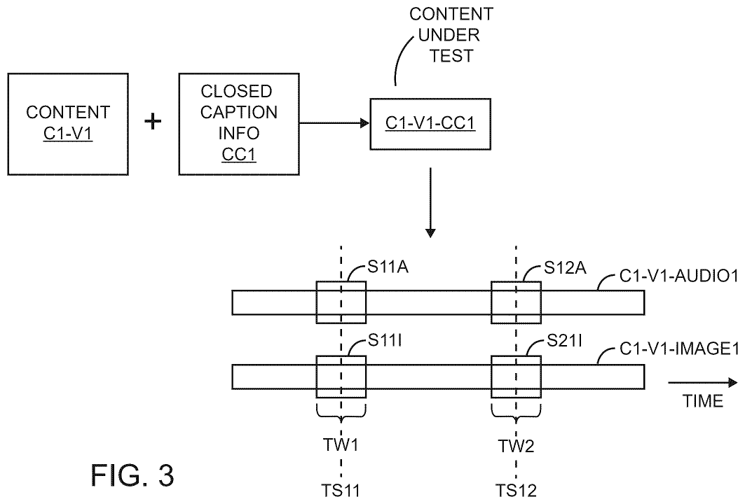

Note that a more specific example of the management resource 140 processing video content under test C1-V1-CC1 using operations in flowchart 200 is shown in FIGS. 3 through 5, resulting in generation of respective match information indicating that the closed-captioned information CC1 was most likely not generated for the version of content C1-V1.

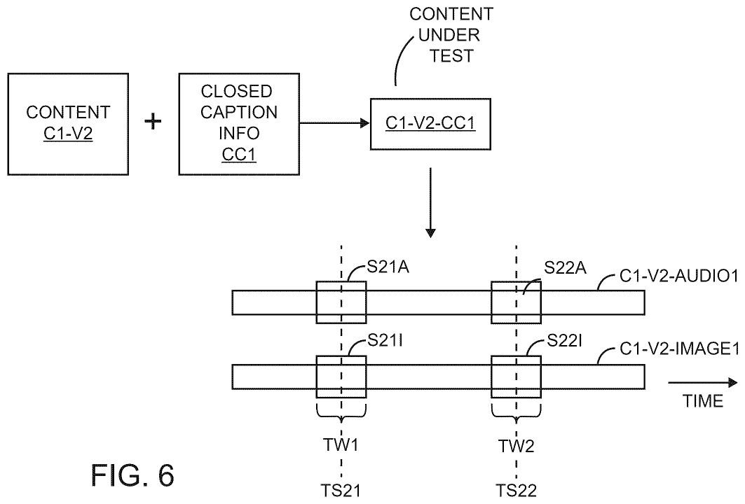

A more specific example of the management resource 140 processing video content under test C1-V2-CC1 using operations in flowchart 200 is shown in FIGS. 6 through 8, resulting in generation of respective match information indicating that the closed-captioned information CC1 was most likely generated for the version of content C1-V2.

Referring again to FIG. 1, in response to detecting the good match of samples associated with the video content C1-V2-CC 1 as previously discussed, the management resource 140 or other suitable entity provides distribution (via communications 175) of the video content C1-V2-CC1 over the network 190 to one or more communication devices CD1, CD2, etc., requesting retrieval and playback of the content C1.

FIG. 3 is an example diagram illustrating combining of closed-captioned information with the first version of content and corresponding analysis of same as discussed herein.

As previously discussed, the management resource 140 or combiner function 165 produces a version of the content under test C1-V1-CC1 based on a combining the version of content C1-V1 and the closed-captioned information CC1. As previously discussed, the closed-captioned information CC1 may or may not have been generated for the version of content C1-V1. To determine whether the text strings associated with the closed-caption information CC1 are synchronized with the version of content C1-V1, the management resource 140 performs the operations as indicated in flowchart 200 to analyze the video content under test C1-V1-CC1, which are further discussed below.

More specifically, the management resource 140 or combiner function 165 produces the content under test C1-V1-C11 via combining of the first version of content C1-V1 and the closed-captioned information CC1. The content under test C1-V1-C11 such as video includes an audio signal C1-V1-AUDIO1 and an image signal C1-V1-IMAGE1 (image data). The audio signal C1-V1-AUDIO1 (audio data) associated with the content under test C1-V1-C11 is encoded to playback sound associated with the image signal C1-V1-IMAGE1 played back on a respective display screen.

In one example, the management resource 140 or other suitable entity chooses a respective timestamp TS11 associated with the content under test C1-V1-CC1 to analyze whether there is sufficient synchronization between the text as indicated by the closed-caption information CC1 and the audio in the version of content C1-V1.

The management resource 140 or other suitable entity can be configured to select or receive a time window value indicating the size of a corresponding time window to analyze audio-image samples. The respective timestamp TS11 can indicate the beginning of the window, middle of the window, end of the window, etc.

Assume in this example that the selected window size is 4 seconds and the chosen time value of TS11 is chosen for the timestamp associated with sampling the audio signal C1-V1-AUDIO1 and the image signal C1-V1-IMAGE1.

Using the time stamp value TS11 and the time window value TW1, the management resource 140: i) obtains a first audio sample S11A (at or around timestamp value TS11 and time range TW1) from an audio signal C1-V1-AUDIO1 associated with the video content under test C1-V1-C11, and ii) obtains a first image sample S11V (at timestamp value TS11 and time range TW11) from an image signal C1-V1-IMAGE1 associated with the first video content under test C1-V1-C11.

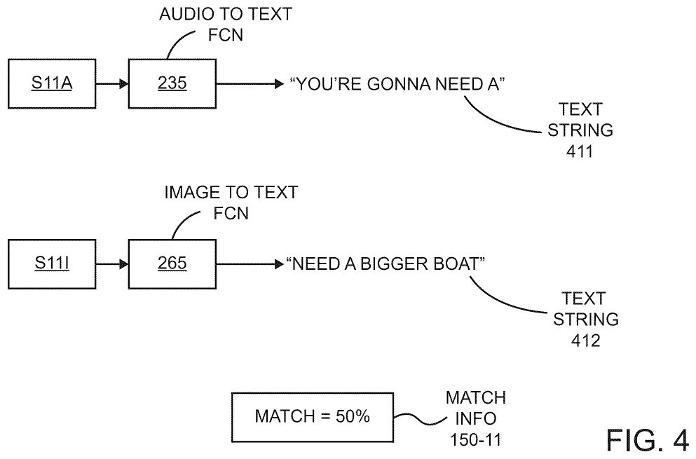

FIG. 4 is an example diagram illustrating analysis of synchronization between audio information and closed-captioned information at a first timestamp as discussed herein.

As shown in FIG. 4, the audio-to-text function 235 converts the received audio sample S11A into the text string 411, which represents audibly spoken words in the first audio sample S11A.

The image-to-text function 265 converts the received image sample S11V (such as closed-captioned information in the form of an image) into the text string 412.

Management resource 140 compares the text string 411 to the text string 412 for similarities or an amount of likeness. For example, the management resource 140 determines that there is a 50 percent match of the words in text string 411 and the text string 412. That is, 2 words “NEED A” of 4 total words are common to both text string 411 and text string 412. In such an instance, the management resource 140 generates the match information 150-11 associated with the sample S11A and S11V to indicate a 50 percent match.

Thus, the management resource 140 receives text string 411 associated with first video content under test C1-V1-C11. The test string 411 (such as “YOU'RE GONNA NEED A”) is derived from audio sample S11A of the first video content under test C1-V1-C11.

The management resource 140 also receives text string 412 associated with the first video content under test C1-V1-C11. The second text string 412 (such as “NEED A BIGGER BOAT”) is derived from a first image sample S11V of the first video content under test C1-V1-C11.

The management resource 140 determines a first quality of playback timing alignment between the first audio sample S11A and the first image sample S11V based on comparison of the first text string 411 and the second text string 412. It is desirable that there is a perfect match between the text string 411 and the text string 412. However, in this case, there is only a 50 percent match of the words between text string 411 and the text string 412. Accordingly, the management resource 140 produces the match information 150-11 (such as including a confidence value) associated with the audio sample S11A and the image sample S11V as being around 50 percent.

Note further that the degree of similarity between the text string 411 and the text string 412 indicates a quality of playback timing alignment between the first audio sample S11A and the first image sample S11V. For example, the closed-captioned information such as “YOU'RE GONNA NEED A” is fairly well aligned with the audio signal “NEED A BIGGER BOAT,” but not perfect.

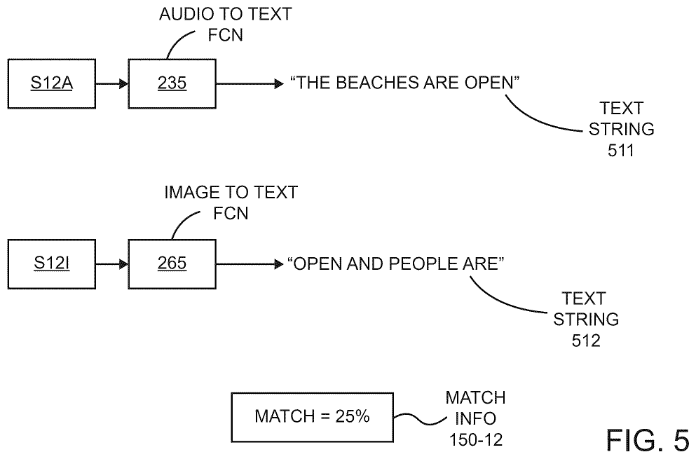

FIG. 5 is an example diagram illustrating analysis of synchronization between audio information and closed-captioned information at a second timestamp as discussed herein.

As shown in FIG. 5, the audio-to-text function 235 converts the received audio sample S12A into the text string 511, which represents encoded audibly spoken words in the audio sample S12A. The image-to-text function 265 converts the received image sample S12V (such as closed-captioned information in the form of an image) into the text string 512.

Management resource 140 compares the text string 511 to the text string 512 for similarities. For example, the management resource 140 determines that there is a 25 percent match of the words in text string 511 and the text string 512. That is, 1 word “OPEN” of 4 total words are common to both text string 511 and text string 512. In such an instance, the management resource 140 generates the match information 150-12 associated with the sample S12A and S12V to indicate a 25 percent match.

Thus, the management resource 140 receives text string 511 associated with first video content under test C1-V1-C11. The test string 511 (such as “THE BEACHES ARE OPEN”) is derived from audio sample S12A of the first video content under test C1-V1-C11.

The management resource 140 also receives text string 512 associated with the first video content under test C1-V1-C11. The second text string 512 (such as “OPEN AND PEOPLE ARE”) is derived from an image sample S12V of the first video content under test C1-V1-C11.

The management resource 140 determines a second quality of playback timing alignment between the audio sample S12A and the image sample S12V based on comparison of the text string 511 and the text string 512. It is desirable that there is a perfect match between the text string 511 and the text string 512. However, in this case, there is only a to 25 percent match of the words between text string 511 and the text string 512.

Accordingly, the management resource 140 produces the match information 150-12 (such as confidence value) associated with the audio sample S12A and the image sample S12V the to be 25 percent or other suitable value.

Note further that the degree of similarity between the text string 511 and the text string 512 indicates a quality of playback timing alignment between the audio sample S12A and the image sample S12V. For example, the closed-captioned image information such as “THE BEACHES ARE OPEN” is poorly aligned with the audio signal “OPEN AND PEOPLE ARE,”

In one example, the management resource 140 produces the match information 150-2 to include match information 150-21 and match information 150-22 associated with analysis of the content under test C1-V2-C11 and corresponding audio signal C1-V2-AUDIO1 and image signal C1-V2-IMAGE1.

FIG. 6 is an example diagram illustrating combining of closed-captioned information with the first version of content and corresponding analysis of tables associated with one or more time instances as discussed herein.

As previously discussed, the management resource 140 or combiner function 165 produces a version of the content under test C1-V2-CC1 based on combining the version of content C1-V2 and the closed-captioned information CC1. As previously discussed, the closed-captioned information CC1 may or may not have been generated for the version of content C1-V2.

To determine whether the text strings associated with the closed-captioned information CC1 are synchronized with the version of content C1-V2, the management resource 140 performs the operations as indicated in flowchart 200 to analyze the video content under test C1-V2-CC1, which are further discussed below.

More specifically, as previously discussed, the management resource 140 or other suitable entity such as combiner function 165 produces the content under test C1-V2-C11 via a combination of the content C1-V2 and the closed-captioned information CC1. The content under test C1-V2-C11 such as video includes an audio signal C1-V2-AUDIO2 and an image signal C1-V2-VIMAGE2. The audio signal C1-V2-AUDIO2 associated with the content under test C1-V2-C11 is encoded to playback sound associated with the image signal C1-V2-IMAGE2 played back on a respective display screen.

In one example, the management resource 140 or other suitable entity chooses a respective timestamp TS21 and corresponding time window associated with the content under test C1-V2-CC1 to analyze whether there is sufficient synchronization between the text as indicated by the closed-caption information CC1 and the audio in the version of content C1-V2.

The management resource 140 or other suitable entity can be configured to select the receive a time window value indicating the size of a corresponding time window to analyze audio-image samples. The respective timestamp TS21 can indicate the beginning of the window, middle of the window, end of the window, etc.

Assume in this example that the selected window size is 4 seconds and the chosen time value of TS21 is chosen for the timestamp associated with sampling the audio signal C1-V2-AUDIO2 and the image signal C1-V2-IMAGE2.

Using the time stamp value TS21 and the time window value TW2 (which may be the same size or different than the time window value TW1), the management resource 140: i) obtains a first audio sample S21A (at timestamp value TS21 and time range TW2) from an audio signal C1-V2-AUDIO2 associated with the video content under test C1-V2-C11, and ii) obtains a first image sample S21V (at timestamp value TS21 and time window range TW2) from an image signal C1-V2-IMAGE2 associated with the video content under test C1-V2-C11.

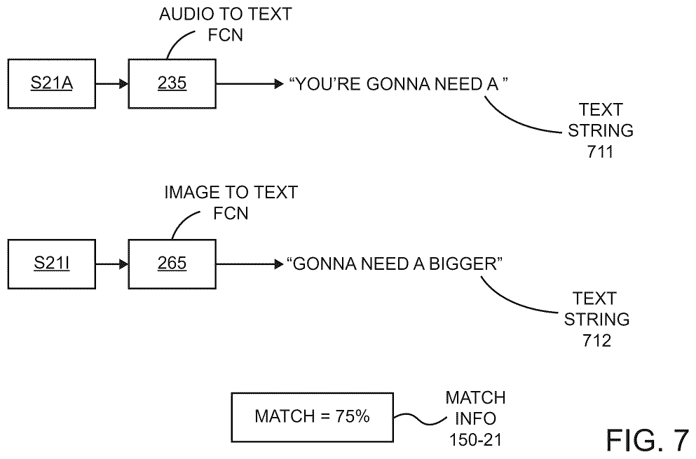

FIG. 7 is an example diagram illustrating analysis of synchronization between audio information and closed-captioned information at a first timestamp as discussed herein.

As shown in FIG. 7, the audio-to-text function 235 converts the received audio sample S21A into the text string 711, which represents encoded audibly spoken words in the audio sample S21A. The image-to-text function 265 converts the received image sample S21V (such as closed-captioned information in the form of an image) into the text string 712.

Management resource 140 compares the text string 711 to the text string 712 for similarities. For example, the management resource 140 determines that there is a 75 percent match of the words in text string 711 and the text string 712. That is, 3 words “GONNA NEED A” of 4 total words are common to both text string 711 and text string 712. In such an instance, the management resource 140 generates the match information 150-21 associated with the sample S21A and S21V to indicate a 75 percent match between the text string 711 and the text string 712.

Thus, the management resource 140 receives text string 711 associated with first video content under test C1-V2-C11. The test string 711 (such as “YOU'RE GONNA NEED A”) is derived from audio sample S21A of the first video content under test C1-V2-C11.

The management resource 140 also receives text string 712 associated with the video content under test C1-V2-C11. The second text string 712 (such as “GONNA NEED A BIGGER”) is derived from a first image sample S21V of the first video content under test C1-V2-C11.

The management resource 140 determines a quality of playback timing alignment between the first audio sample S21A and the image sample S21V based on comparison of the text string 711 and the text string 712.

As previously discussed, it is desirable that there is a perfect match between the text string 711 and the text string 712. However, in this case, there is only a 75 percent match of the words (“GONNA NEED A”) between text string 711 and the text string 712. Accordingly, the management resource 140 produces the match information 150-21 (such as confidence value) associated with the audio sample S21A and the image sample S21V to be 75 percent.

Note further that the degree of similarity between the text string 711 and the text string 712 indicates a quality of playback timing alignment between the audio sample S21A and the image sample S21V. For example, the closed-captioned information such as “YOU'RE GONNA NEED A” is well aligned with the audio signal “GONNA NEED A BIGGER.”

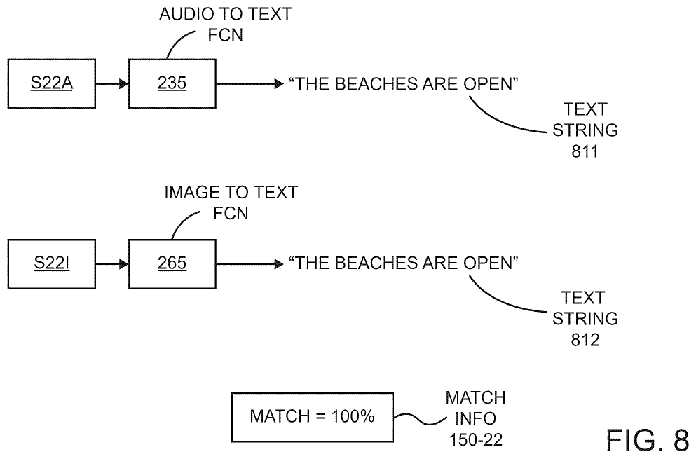

FIG. 8 is an example diagram illustrating analysis of synchronization between audio information and closed-captioned information at a timestamp as discussed herein.

As shown in FIG. 8, the audio-to-text function 235 converts the received audio sample S22A into the text string 811, which represents encoded audibly spoken words in the audio sample S22A. The image-to-text function 265 converts the received image sample S22V (such as closed-captioned information in the form of an image) into the text string 812.

Management resource 140 compares the text string 811 to the text string 812 for similarities. For example, the management resource 140 determines that there is a 100 percent match of the words in text string 811 and the text string 812. That is, the words in the text string 811 are identical to the words in the text string 812. In such an instance, the management resource 140 generates the match information 150-22 associated with the sample S22A and S22V to indicate a 100 percent match.

Thus, the management resource 140 receives text string 811 associated with first video content under test C1-V2-C11. The test string 811 (such as “THE BEACHES ARE OPEN”) is derived from audio sample S22A of the video content under test C1-V2-C11.

The management resource 140 also receives text string 812 associated with the first video content under test C1-V2-C11. The second text string 812 (such as “THE BEACHES ARE OPEN”) is derived from an image sample S22V of the video content under test C1-V2-C11.

The management resource 140 determines a second quality of playback timing alignment between the audio sample S22A and the image sample S22V based on comparison of the text string 811 and the text string 812 for a window of time around time TS22. It is desirable that there is a perfect match between the text string 811 and the text string 812. In this case, there is a 100 percent match of the words in text string 811 and the text string 812.

Accordingly, the management resource 140 produces the match information 150-22 (such as confidence value) associated with the audio sample S22A and the image sample S22V the to be 100 percent or other suitable value.

Note further that the degree of similarity between the text string 811 and the text string 812 indicates a quality of playback timing alignment between the audio sample S22A and the image sample S22V. For example, the closed-captioned image information such as “THE BEACHES ARE OPEN” is perfectly aligned with the audio signal “THE BEACHES ARE OPEN.”

In one example, the management resource 140 produces the match information 150-2 to include match information 150-21 and match information 150-22 associated with analysis of the content under test C1-V2-C11 and corresponding audio signal C1-V2-AUDIO2 and image signal C1-V2-IMAGE2.

As previously discussed, the management resource 140 can be configured to determine that the closed-captioned information CC1 was generated for the second version of content C1-V2 based on the match information 150-2 indicating a better match of the closed-captioned information CC1 to the second version of content C1-V2 than the match information 150-1 indicating a match of the closed-captioned information CC1 to the first version of content C1-V1. For example, the analysis of the closed-captioned information CC1 with respect to the first version of content C1 indicates a likeness of 50 percent for time sample TS11 and 25 percent for time sample TS12. The analysis of the closed-captioned information CC1 with respect to the second version of content C1 indicates a likeness of 75 percent for time sample TS21 and 100 percent for time sample TS22. Thus, the match information 150-2 (150-21 and 150-22) indicates the best timing alignment.

As previously discussed, the management resource 140 or other suitable playback entity can be configured to analyze synchronicity of the closed-captioned information CC1 during playback of the corresponding content C1 such as by obtaining an audio sample in an image sample associated with the first content C1. In response to detecting that a first quality of playback timing alignment between audio and image information falls below a threshold level, the management resource can be configured to adjust synchronization of playing back the audio signal (and closed-captioned text encoded in the image signal) such that appropriate closed caption text is playback on a display screen at the same time that corresponding audio is played back.

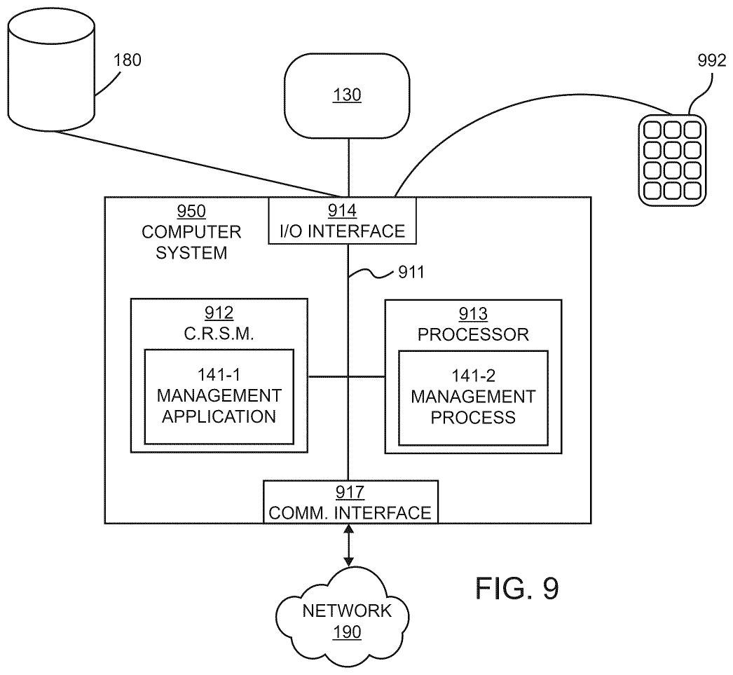

FIG. 9 is an example block diagram of a computer system for implementing any of the operations as previously discussed according to examples herein.

Any of the resources (communication device CD1, communication device CD2, communication management resource 140, etc.) as discussed herein can be configured to include computer processor hardware and/or corresponding executable instructions to carry out the different operations as discussed herein via computer system 950.

As shown, computer system 950 of the present example includes an interconnect 911 coupling computer readable storage media 912 such as a non-transitory type of media or, more generally, computer readable hardware which can be any suitable type of hardware storage medium in which digital information can be stored and retrieved, a processor 913 (computer processor hardware), I/O interface 914, and a communications interface 917.

I/O interface(s) 914 supports connectivity to repository 980 and input resource 992.

Computer readable storage medium 912 (such as computer readable hardware or other suitable entity) can be a hardware storage device or resource such as memory, optical storage, hard drive, floppy disk, etc. In one example, the computer readable storage medium 912 stores instructions and/or data. Computer readable storage medium 912 can be a non-transitory storage medium or include non-transitory storage hardware.

As shown, computer readable storage media 912 can be encoded with communication management application 140-1 (e.g., including instructions) to carry out any of the operations as discussed herein.

During operation of one example, processor 913 accesses computer readable storage media 912 via the use of interconnect 911 in order to launch, run, execute, interpret or otherwise perform the instructions in management application 140-1 stored on computer readable storage medium 912. Execution of the management application 140-1 produces the management process 140-2 to carry out any of the operations and/or processes as discussed herein.

Those skilled in the art will understand that the computer system 950 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein. In one example, the control system 950 can include or be implemented in virtualization environments such as the cloud.

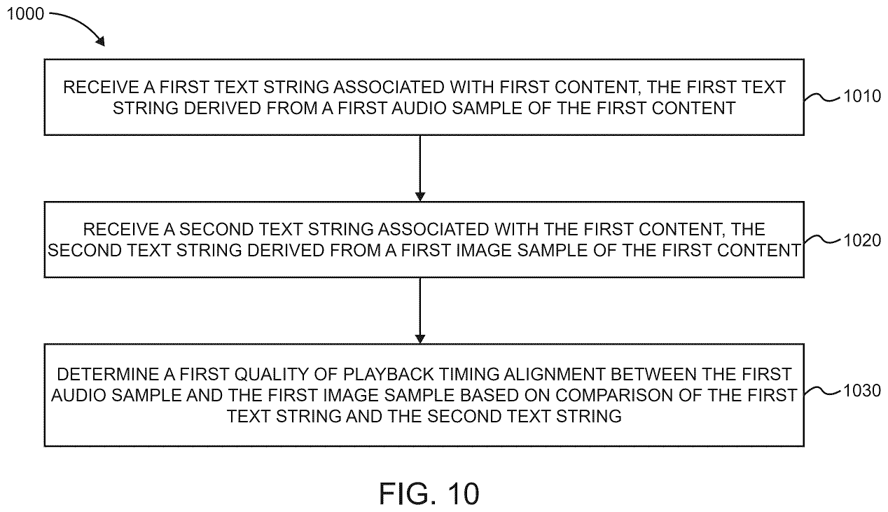

Functionality supported by the different resources will now be discussed via flowchart in FIG. 10. Note that the steps in the flowcharts below can be executed in any suitable order.

FIG. 10 is a flowchart 1000 illustrating an example method according to examples. Note that flowchart 1000 overlaps/captures general concepts as discussed herein.

In processing operation 1010, the management resource 140 receives a first text string associated with first content, the first text string derived from a first audio sample of the first content.

In processing operation 1020, the management resource receives a second text string associated with the first content, the second text string derived from a first image sample of the first content.

In processing operation 1030, the management resource determines a first quality of playback timing alignment between the first audio sample and the first image sample based on comparison of the first text string and the second text string.

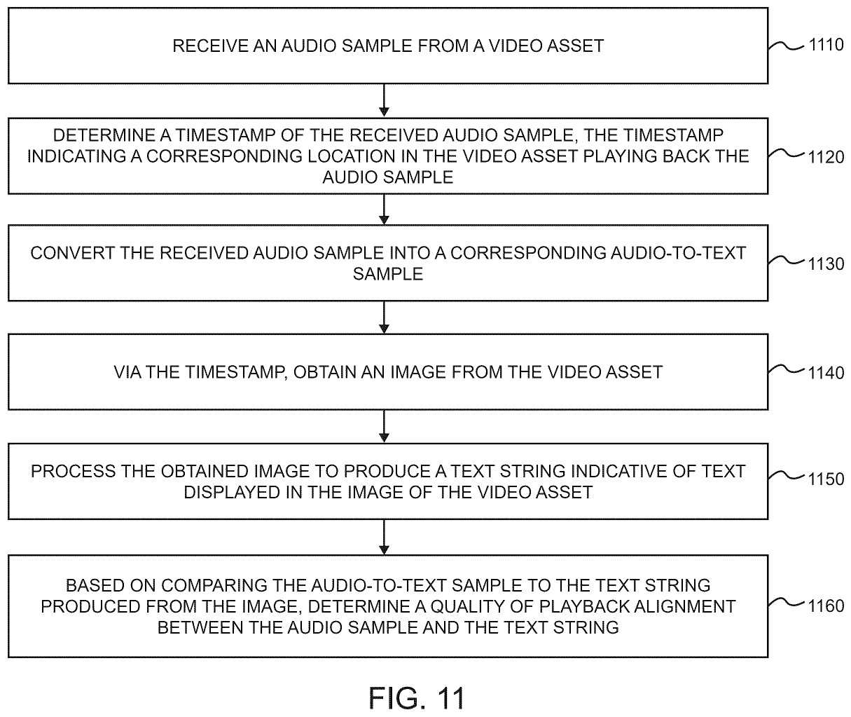

FIG. 11 is a flowchart 1100 illustrating an example method according to examples. Note that flowchart 1100 overlaps/captures general concepts as discussed herein.

In processing operation 1110, the management resource receives an audio sample from a video asset.

In processing operation 1120, the management resource determines a timestamp of the received audio sample, the timestamp indicating a corresponding location in the video asset playing back the audio sample.

In processing operation 1130, the management resource converts the received audio sample into a corresponding audio-to-text sample.

In processing operation 1140, via the timestamp, the management resource obtains an image from the video asset.

In processing operation 1150, the management resource processes the obtained image to produce a text string indicative of text displayed in the image of the video asset.

In processing operation 1160, based on comparing the audio-to-text sample to the text string produced from the image, the management resource determines a quality of playback alignment (synchronization) between the audio sample and the text string.

Note again that techniques herein are well suited to facilitate synchronization testing of close caption files with their corresponding video asset. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
receiving a first text string associated with first content, the first text string derived from a first audio sample of the first content;
receiving a second text string associated with the first content, the second text string derived from a first image sample of the first content; and
determining a first quality of playback timing alignment between the first audio sample and the first image sample based on comparison of the first text string and the second text string.

2. The method as in claim 1, wherein the first audio sample is obtained from an audio signal associated with the first content; and
wherein the first image sample is obtained from an image signal associated with the first content.

3. The method as in claim 2, wherein the image signal includes text information encoded for playback on a display screen.

4. The method as in claim 2 further comprising:
using a time stamp value associated with the first audio sample to obtain the first image sample of the first content.

5. The method as in claim 1, wherein a first quality of playback timing alignment between the first audio sample and the first image sample includes determining a degree to which the first text string and the second text string are similar to each other.

6. The method as in claim 5, wherein determining the degree to which the first text string and the second text string are similar to each other includes:
producing a metric based on a percentage of first words present in the first text string that match second words present in the second text string.

7. The method as in claim 1 further comprising:
receiving a third text string, the third text string associated with second content, the third text string derived from a second audio sample, the second audio sample obtained from the second content;
receiving a fourth text string, the fourth text string associated with the second content, the fourth second text string derived from a second image sample from the second content; and
determining a second quality of playback timing alignment between the second audio sample and the second image sample based on comparison of the third text string and the fourth text string.

8. The method as in claim 7 further comprising:
producing a first metric indicating a degree to which the first text string and the second text string are similar to each other; and
producing a second metric indicating a degree to which the third text string and the fourth text string are similar to each other.

9. The method as in claim 8, wherein the second text string and the fourth text string are obtained from closed-captioned information, the method further comprising:
based on comparing the first metric and the second metric, determining which of the first content or the second content the closed-captioned information is better synchronized.

10. The method as in claim 1 further comprising:
converting the first audio sample of the first content into the first text string, the first text string including text representing words spoken in the first audio sample.

11. The method as in claim 1 further comprising:
receiving a third text string associated with the first content, the third text string derived from a second audio sample of the first content;
receiving a fourth text string associated with the first content, the fourth text string derived from a second image sample of the first content; and
determining a second quality of playback timing alignment between the second audio sample and the second image sample based on comparison of the third text string and the fourth text string.

12. The method as in claim 11, wherein the first audio sample and the second audio sample are obtained from an audio signal associated with the first content;
wherein the first image sample and the second image sample are obtained from an image signal associated with the first content; and
the method further comprising: based on the determined first quality of playback timing alignment and the determined second quality of playback timing alignment, producing a metric indicating a degree of synchronization between the audio signal and the image signal.

13. The method as in claim 1, wherein the first audio sample is obtained from an audio signal associated with the first content;
wherein the first image sample is obtained from an image signal associated with the first content, the method further comprising:
in response to detecting that the first quality of playback timing alignment falls below a threshold level, adjusting synchronization of playing back the audio signal and closed-captioned text encoded in the image signal.

14. A system comprising:
management hardware operative to:
receive a first text string associated with first content, the first text string derived from a first audio sample of the first content;
receive a second text string associated with the first content, the second text string derived from a first image sample of the first content; and
determine a first quality of playback timing alignment between the first audio sample and the first image sample based on comparison of the first text string and the second text string.

15. The system as in claim 14, wherein the first audio sample is obtained from an audio signal associated with the first content; and
wherein the first image sample is obtained from an image signal associated with the first content.

16. The system as in claim 15, wherein the image signal includes text information encoded for playback on a display screen.

17. The system as in claim 15, wherein the management hardware is further operative to:
use a time stamp value associated with the first audio sample to obtain the first image sample of the first content.

18. The system as in claim 14, wherein a first quality of playback timing alignment between the first audio sample and the first image sample includes determining a degree to which the first text string and the second text string are similar to each other.

19. The system as in claim 18, wherein the management hardware is further operative to:
produce a metric based on a percentage of first words present in the first text string that match second words present in the second text string.

20. The system as in claim 14, wherein the management hardware is further operative to:
receive a third text string, the third text string associated with second content, the third text string derived from a second audio sample, the second audio sample obtained from the second content;
receive a fourth text string, the fourth text string associated with the second content, the fourth second text string derived from a second image sample from the second content; and
determine a second quality of playback timing alignment between the second audio sample and the second image sample based on comparison of the third text string and the fourth text string.

21. The system as in claim 20, wherein the management hardware is further operative to:
produce a first metric indicating a degree to which the first text string and the second text string are similar to each other; and
produce a second metric indicating a degree to which the third text string and the fourth text string are similar to each other.

22. The system as in claim 21, wherein the second text string and the fourth text string are obtained from closed-captioned information, wherein the management hardware is further operative to:
based on comparing the first metric and the second metric, determine which of the first content or the second content the closed-captioned information is better synchronized.

23. The system as in claim 14, wherein the management hardware is further operative to:
convert the first audio sample of the first content into the first text string, the first text string including text representing words spoken in the first audio sample.

24. The system as in claim 14, wherein the management hardware is further operative to:
receive a third text string associated with the first content, the third text string derived from a second audio sample of the first content;
receive a fourth text string associated with the first content, the fourth text string derived from a second image sample of the first content; and
determine a second quality of playback timing alignment between the second audio sample and the second image sample based on comparison of the third text string and the fourth text string.

25. The system as in claim 24, wherein the first audio sample and the second audio sample are obtained from an audio signal associated with the first content;
wherein the first image sample and the second image sample are obtained from an image signal associated with the first content; and
the method further comprising: based on the determined first quality of playback timing alignment and the determined second quality of playback timing alignment, producing a metric indicating a degree of synchronization between the audio signal and the image signal.

26. The system as in claim 14, wherein the first audio sample is obtained from an audio signal associated with the first content;
wherein the first image sample is obtained from an image signal associated with the first content, wherein the management hardware is further operative to: in response to detecting that the first quality of playback timing alignment falls below a threshold level, adjust synchronization of playing back the audio signal and closed-captioned text encoded in the image signal.

27. Computer-readable storage hardware having instructions stored thereon, the instructions, when carried out by computer processor hardware, cause the computer processor hardware to:
receive a first text string associated with first content, the first text string derived from a first audio sample of the first content;
receive a second text string associated with the first content, the second text string derived from a first image sample of the first content; and
determine a first quality of playback timing alignment between the first audio sample and the first image sample based on comparison of the first text string and the second text string.

28. A method comprising:
receiving an audio sample from a video asset;
determining a timestamp of the received audio sample, the timestamp indicating a corresponding location in the video asset playing back the audio sample;
converting the received audio sample into a corresponding audio-to-text sample;
via the timestamp, obtaining image data from the video asset;
processing the obtained image data to produce a text string indicative of text displayed in the image data of the video asset; and
based on comparing the audio-to-text sample to the text string produced from the image, determining a quality of playback alignment between the audio sample and the text string.
